(19) United States
(12) Patent Application Publication
(10) Pub. No.: US 2006/0243324 A1
(43) Pub. Date: Nov. 2, 2006

(54) Automatic start additive injection system for fire-fighting vehicles

(75) Inventors: Andrew P. Klein, Appleton, WI (US); Chad J. Pietrowski, Appleton, WI (US)

Correspondence Address: RYAN KROMHOLZ & MANION, S.C., POST OFFICE BOX 26618, MILWAUKEE, WI, 53226, US

(73) Assignee: Pierce Manufacturing Inc.

(21) Appl. No.: 11/195,163

(22) Filed: Aug. 2, 2005

Related U.S. Application Data
(60) Provisional application No. 60/676,366, filed on Apr. 29, 2005.

(51) Int. Cl. G05D 11/00

(52) U.S. Cl. 137/111

(57) ABSTRACT

An additive pump system for fire-fighting vehicles is automatically engaged when the water pump is engaged. Upon engagement of the water pump, the water pump communicates with a hydraulic pump to engage the hydraulic pump. Engagement of the hydraulic pump results in a rise in hydraulic pressure. A pressure switch is tripped when a pressure of a pre-determined set point is reached. The pressure switch communicates with a controller to indicate that sufficient pressure has been obtained. In response to the receiving the signal of sufficient hydraulic pressure, the controller signals the additive pump system to engage the additive pump system.

### RELATED APPLICATION

This application claims the benefit of co-pending provisional patent application Ser. No. 60/676,366, filed 29 Apr. 2005.

### FIELD OF THE INVENTION

The invention relates to additive injection systems for fire-fighting or emergency vehicles. In particular, the invention relates to an auto-start additive injection system and/or compressed air injection system for such vehicles.

### BACKGROUND OF THE INVENTION

Conventional additive systems for fighting fires employ numerous mechanisms for supplying an additive, typically a foam liquid concentrate such as Class A or Class B firefighting foam, via supply conduits to one or more of the discharge outlets of a water pump in a pre-determined ratio of foam concentrate to water. The system may also utilize other chemical agents designed to be injected into a water stream, for example chemical agents used to fight bioterrorism. Examples of additive proportioning systems are disclosed in Klein et al. U.S. Pat. No. 6,725,940 and Juidici et al. U.S. Pat. No. 6,684,959, both of which are incorporated herein by reference.

Typically, an operator must manually initiate the foam proportioning system, e.g., by engaging an on/off switch. Arrival at the scene of a fire is generally a stressful time for fire-fighting personnel. Initial confusion or communication difficulties may result in the failure of a fire fighter to engage the foam injection system at the appropriate time. As a result, the water flow system may be engaged without the foam injection system being engaged, leading to less than the optimal or desired fire-fighting capabilities.

Arvidson et al. U.S. Pat. No. 6,766,863 discloses a foam injection system in which the foam delivery system is automatically engaged upon detection of water flow in a delivery hose. An inherent drawback of such systems is that the use of a water flow signal may provide a false signal due to simple vibration of the flow meter or false signals due to movement of the fire-fighting vehicle.

The need therefore remains for auto-start foam injection systems that activate the foam injection or foam control system upon activation of the water flow system without operator intervention and while preventing undesired or untimely activation. The need further remains for an auto-start system that requires minimal or no additional operator training.

### SUMMARY OF THE INVENTION

A fluid delivery system for fire-fighting vehicles and the like comprising a hydraulic system including a hydraulic pump coupled to a hydraulic manifold block whereby hydraulic fluid pressure in the hydraulic system increases in response to engagement of the hydraulic pump, a water pump in communication with the hydraulic pump whereby the hydraulic pump is automatically engaged upon engagement of the water pump, an additive injection system coupled to the hydraulic manifold block, a pressure switch in communication with the hydraulic system, and a controller in communication with the pressure switch. Alternatively, the fluid delivery system for fire-fighting vehicles and the like comprises a hydraulic system including a hydraulic pump coupled to a hydraulic manifold block whereby hydraulic fluid pressure in the hydraulic system increases in response to engagement of the hydraulic pump, a water pump in communication with the hydraulic pump whereby the hydraulic pump is automatically engaged upon engagement of the water pump, an additive injection system coupled to the hydraulic manifold block, means for detecting hydraulic fluid pressure in the hydraulic system, and means for automatically engaging the additive pump system when the detected hydraulic fluid pressure passes a pre-determined set point. An other embodiment may be described as a fluid delivery system for fire-fighting vehicles and the like comprising an additive injection system coupled to a hydraulic pump system, means for detecting engagement of the hydraulic pump system, and means for automatically engaging the additive injection system upon detection of engagement of the hydraulic pump system. A further embodiment includes a fluid delivery system for fire-fighting vehicles comprising a hydraulic system including a hydraulic pump coupled to a hydraulic manifold block whereby a characteristic of hydraulic fluid in the hydraulic system changes in response to engagement of the hydraulic pump, a water pump in communication with the hydraulic pump whereby the hydraulic pump is automatically engaged upon engagement of the water pump, an additive injection system coupled to the hydraulic manifold block, means for detecting a change in the characteristic of the hydraulic fluid, and means for automatically engaging the additive injection system upon detection of the change in the characteristic of the hydraulic fluid. Yet another embodiment can be described as a fluid delivery system for fire-fighting vehicles and the like comprising a hydraulic system including a hydraulic pump coupled to a hydraulic manifold block whereby a characteristic of the hydraulic fluid in the hydraulic system changes in response to engagement of the hydraulic pump, a water pump in communication with the hydraulic pump whereby the hydraulic pump is automatically engaged upon engagement of the water pump, a compressed air injection system coupled to the hydraulic system, means for detecting a change in the characteristic of the hydraulic fluid, and means for automatically engaging the compressed air injection system upon detection of the change in the characteristic of the hydraulic fluid.

### BRIEF DESCRIPTION OF THE DRAWINGS

FIG. 1 is a schematic illustrating a hydraulically driven additive injection system having an automatic start feature providing for automatic start of the additive injection system upon engagement of the water pump.

FIG. 2 is a schematic of an alternative embodiment of a hydraulically driven additive injection system having an automatic start feature.

FIG. 3 is a schematic of a system having a hydraulically driven additive injection system and a hydraulically driven compressed air foam system and providing for automatic start of both the additive injection system and the compressed air foam system upon engagement of the water pump.

FIG. 4 is a schematic of a system having an additive injection system driven by non-hydraulic means and a hydraulically driven compressed air foam system providing for automatic start of the compressed air foam system upon engagement of the water pump.

### DESCRIPTION OF THE PREFERRED EMBODIMENT

Although the disclosure hereof is detailed and exact to enable those skilled in the art to practice the invention, the physical embodiments herein disclosed merely exemplify the invention that may be embodied in other specific structures. While the preferred embodiment has been described, the details may be changed without departing from the invention, which is defined by the claims.

FIG. 1 illustrates a system 10 for the automatic engagement of a foam pump or other additive injection system 12 for fire-fighting vehicles. The automatic engagement of the additive injection system 12 greatly simplifies operation by eliminating the need for an operator to manually switch the additive injection system 12 on or otherwise manually engage the additive injection system 12.

Any suitable chemical can act as the additive utilized in the system 10. As previously disclosed, the suitable chemical may have an application of decontamination with respect to an act of bioterrorism. Typically, liquid foam concentrate is the additive that is injected into the water for fire fighting purposes. The most common commercially available liquid foam concentrates are Class A and Class B liquid foam concentrate. However, additives other than a liquid foam concentrate may be used based on fire fighting efficacy.

In the illustrated embodiment, the additive injection system 12 takes the form of a hydraulically-driven additive pump system. Examples of hydraulically-driven additive pump systems 12 are disclosed in commonly-owned patents Juidici et al. U.S. Pat. No. 6,684,959 and Klein et al. U.S. Pat. No. 6,725,940. The particular configuration of the additive pump system 12 can vary and therefore will not be discussed in detail.

The additive pump system 12 is driven by a conventional hydraulic system of the type well-known in the art. A hydraulic pump 14 receives hydraulic fluid, e.g., oil, from a hydraulic manifold block 16 through an intake line 18 and returns hydraulic fluid to the hydraulic manifold block 16 through a return line 20. The additive pump system 12 receives hydraulic fluid from the hydraulic manifold block 16 through an intake line 22 and returns hydraulic fluid to the hydraulic manifold block 16 through a return line 24.

A controller 26, e.g., a programmable digital controller, communicates with the additive pump system 12 through signal line 28 to regulate the speed of an additive pump (not shown) to maintain a desired ratio of additive to water.

A primary fire fighting fluid, such as water, is supplied via a water supply source 30, e.g., a fire hydrant. The water supply source 30 is connected to a water pump 32 through an intake conduit 34 as is common in fire-fighting apparatus. Water is directed from the water pump 32 and into a mixing manifold 36 through a conduit 38. Additive is directed from the additive pump system 12 to the mixing manifold 36 though a conduit 40 for mixing with the water in a desired ratio. The water/foam mixture is then discharged through a discharge conduit 42, which is typically a hose and nozzle.

The system 10 provides for automatic engagement of the additive pump system 12, i.e., the foam delivery system, when the water pump 32 is engaged. In the embodiment illustrated in FIG. 1, the water pump 32 is coupled (as represented by line 43) to the hydraulic pump 14 so that engagement of the water pump 32 automatically engages the hydraulic pump 14 that provides fluid power to the additive pump system 12.

Engagement of the hydraulic pump 14 results in a rise in hydraulic pressure. As the hydraulic pressure passes a pre-determined setpoint, e.g., 60 psi, a pressure switch 44 (located in a signal line 46 providing communication between the block 16 and the controller 26) or other signal means is tripped. In a preferred embodiment, the pressure switch 44 is an electric pressure switch manufactured by GEM Sensors, model number PS 75-20-4MNZ-C-HC-FS60PSIR. The use of a hydraulic pressure switch 44 provides a measurable, accurate way of turning on power to the system 12 that is not affected by vibration or movement of the fire-fighting vehicle.

When tripped, the pressure switch 44 sends a signal through signal line 46 to the controller 26 indicating that there is adequate pressure in the system 10. In response to this indication of sufficient pressure 26, the controller 26 activates the additive pump system 12 to initiate foam delivery. The controller 26 may send an activation signal directly to the additive injection system 12 via signal line 28 to initiate activation of the system 12. Alternatively, the controller may send a signal to the hydraulic manifold block 16 (e.g., to open a valve within the manifold block 16) to initiate hydraulic fluid flow from the manifold block 16 to the additive injection system 12 to thereby engage the system 12 (not shown).

During normal operation, the hydraulic pressure may continue to rise above the setpoint. Upon system deactivation or shutdown, the hydraulic pressure will drop and once again reach the pre-determined setpoint. Therefore, it is desirable that the pressure switch 44 is adapted to send the activation signal upon detection of the pre-determined setpoint only upon detecting a rising hydraulic pressure and not when detecting a decreasing hydraulic pressure.

It will be readily apparent to one of skill in the art that engagement of the hydraulic pump 14 and resulting activation of the hydraulic fluid system may result in changes in other characteristics of the hydraulic fluid, e.g., hydraulic fluid flow rate or temperature. Therefore, it is contemplated that sensor 44 may be responsive to changes in other characteristics of hydraulic fluid other than pressure.

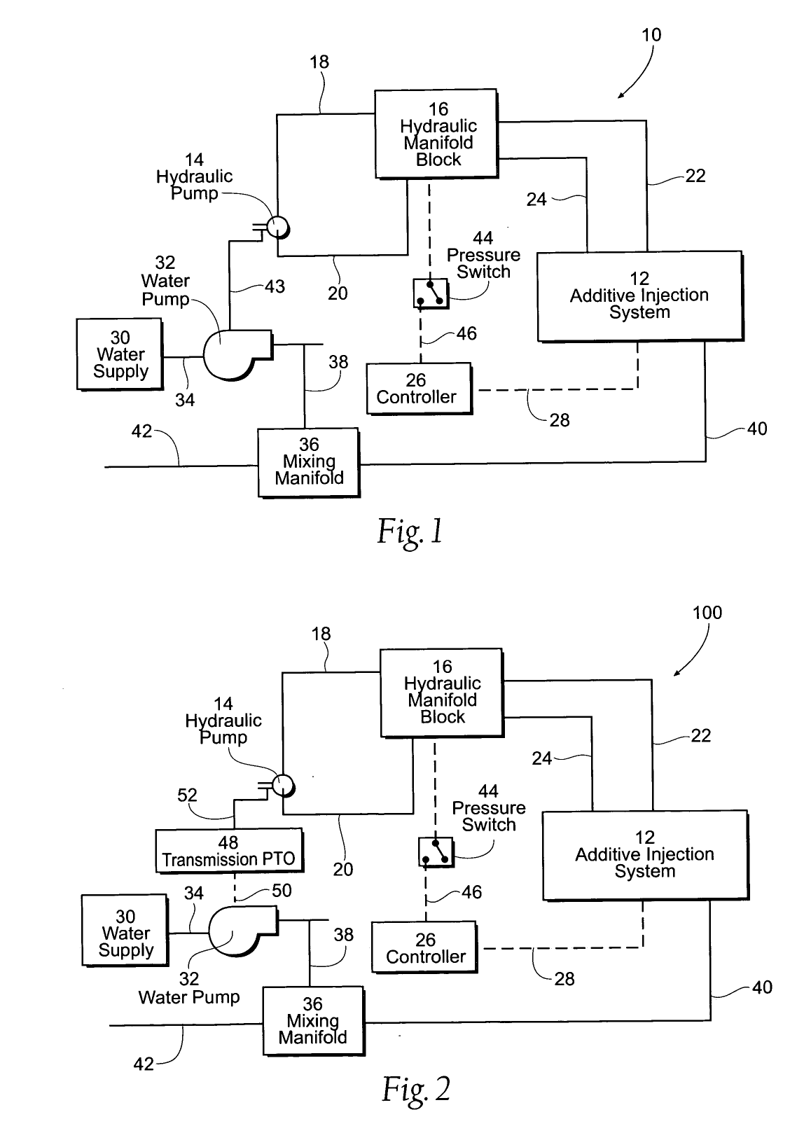

An alternative system 100 is illustrated in FIG. 2. In the illustrated embodiment, engagement of the water pump 32 sends a signal to the fire-fighting vehicle's transmission power take off 48 through signal line 50. The transmission power take off 48 is coupled to the hydraulic pump 14 (as represented by line 52). Engagement of the hydraulic pump 14 results in a rise in hydraulic pressure and trips the pressure switch 44, as previously described.

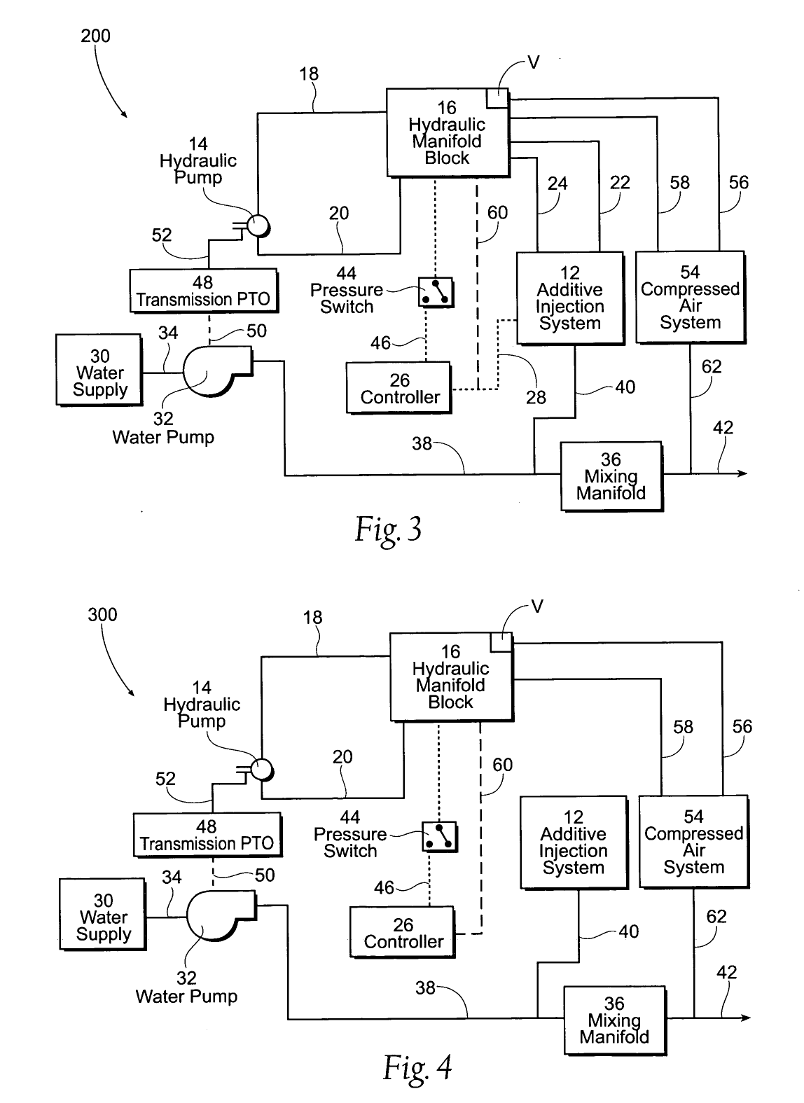

FIG. 3 illustrates an alternative system 200 having a hydraulically driven additive injection system 12 and a hydraulically driven compressed air system 54. The system 300 provides for automatic engagement and start of the additive injection system 12 and the compressed air system 54 when the water pump 32 is engaged.

Similar to the system 100 previously described, activation of the water pump 32 engages the hydraulic pump 14 through the transmission PTO 48. Engagement of the hydraulic pump 14 results in an increase in the pressure of hydraulic fluid. When a pre-selected pressure is reached, the pressure switch 44 is tripped, sending a signal to the controller 26 to engage the additive injection system 12.

The hydraulic manifold block 16 also communicates with the compressed air system 54 through intake line 56 and return line 58. Upon receiving a signal indicating sufficient pressure (i.e., upon tripping of pressure switch 44), the controller 26 sends a signal to the hydraulic manifold block 16 through signal line 60 to open a valve V, thereby initiating flow of hydraulic fluid from the manifold block 16 to the compressed air system 54 (through line 56) to activate the compressed air system 54 for normal operation. In a representative embodiment, the valve V is a solenoid valve model SB16-DC-12F manufactured by Oil Control. In operation, the compressed air system 54 injects a desired quantity of compressed air through line 62 into the discharge line 42.

Alternatively, the controller 26 may send a signal directly to the compressed air system 54 to activate the compressed air system 54 (not shown).

The system 200 therefore permits automatic activation of both the additive injection system 12 and the compressed air system 54 upon engagement of hydraulic system by activation of the water pump 32.

FIG. 4 illustrates an alternative system 300. System 300 provides a hydraulically driven compressed air system 54 and an additive injection system 12 that is not hydraulically driven (e.g., driven by a rotary gear motor). In some cases, it may be desirable to provide for automatic engagement of the compressed air system 54 upon engagement of the water pump 32 (and corresponding activation of the hydraulic system) while still permitting manual or other activation of the additive injection system 12.

Because the additive injection system 12 is not coupled to the hydraulic manifold block 16, activation of the hydraulic system by engagement of the water pump 32 does not automatically activate the additive injection system 12. That is, the additive injection system 12 must be manually engaged by the operator.

Similar to the system 200 previously described, upon tripping of pressure switch 44, the controller 26 opens valve V to initiate hydraulic fluid flow to activate the compressed air system 54.

Alternatively, the controller 26 may send a signal directly to the compressed air system 54 to activate the compressed air system 54 (not shown).

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We Claim:

1. A fluid delivery system for fire-fighting vehicles comprising:
a hydraulic system including a hydraulic pump coupled to a hydraulic manifold block, hydraulic fluid pressure in the hydraulic system increasing in response to engagement of the hydraulic pump;
a water pump in communication with the hydraulic pump whereby the hydraulic pump is automatically engaged upon engagement of the water pump;
an additive injection system coupled to the hydraulic manifold block;
a pressure switch in communication with the hydraulic system; and
a controller in communication with the pressure switch.

2. A fluid delivery system as in claim 1,
wherein the controller is in communication with the additive injection system.

3. A fluid delivery system as in claim 1,
wherein the controller is in communication with the hydraulic manifold block.

4. A fluid delivery system as in claim 1, further comprising:
a compressed air injection system coupled to the hydraulic manifold block.

5. A fluid delivery system as in claim 1,
wherein the pressure switch sends a sufficient system pressure signal to the controller when the hydraulic fluid pressure reaches a pre-determined set point.

6. A fluid delivery system as in claim 5,
wherein the controller sends a signal to the additive injection system to automatically engage the additive injection system upon receipt of the sufficient system pressure signal.

7. A fluid delivery system as in claim 5,
wherein the pressure switch sends the sufficient system pressure signal only upon sensing a rising hydraulic fluid pressure.

8. A fluid delivery system as in claim 5,
wherein the pre-determined set point is approximately 60 psi.

9. A fluid delivery system as in claim 5,
wherein the controller sends a signal to the hydraulic manifold block upon receipt of the sufficient system pressure signal.

10. A fluid delivery system as in claim 9,
wherein a valve is activated upon receipt of the signal by the hydraulic manifold block.

11. A fluid delivery system as in claim 10,
wherein the valve is a solenoid valve.

12. A fluid delivery system for fire-fighting vehicles comprising:
a hydraulic system including a hydraulic pump coupled to a hydraulic manifold block, hydraulic fluid pressure in the hydraulic system increasing in response to engagement of the hydraulic pump;
a water pump in communication with the hydraulic pump whereby the hydraulic pump is automatically engaged upon engagement of the water pump;
an additive injection system coupled to the hydraulic manifold block;
means for detecting hydraulic fluid pressure in the hydraulic system; and
means for automatically engaging the additive pump system when the detected hydraulic fluid pressure passes a pre-determined set point.

13. A fluid delivery system as in claim 12, further comprising:
a compressed air injection system coupled to the hydraulic manifold block; and
means for automatically engaging the compressed air injection system when the detected hydraulic fluid pressure passes the pre-determined set point.

14. A fluid delivery system for fire-fighting vehicles comprising:
an additive injection system coupled to a hydraulic pump system;
means for detecting engagement of the hydraulic pump system; and
means for automatically engaging the additive injection system upon detection of engagement of the hydraulic pump system.

15. A fluid delivery system as in claim 14, further comprising:
a compressed air injection system coupled to the hydraulic pump system; and
means for automatically engaging the compressed air injection system upon detection of engagement of the hydraulic pump system.

16. A fluid delivery system for fire-fighting vehicles comprising:
a hydraulic system including a hydraulic pump coupled to a hydraulic manifold block, a characteristic of hydraulic fluid in the hydraulic system changing in response to engagement of the hydraulic pump;
a water pump in communication with the hydraulic pump whereby the hydraulic pump is automatically engaged upon engagement of the water pump;
an additive injection system coupled to the hydraulic manifold block;
means for detecting a change in the characteristic of the hydraulic fluid; and
means for automatically engaging the additive injection system upon detection of the change in the characteristic of the hydraulic fluid.

17. A fluid delivery system as in claim 16, further comprising:
a compressed air injection system coupled to the hydraulic pump system; and
means for automatically engaging the compressed air injection system upon detection of the change in the characteristic of the hydraulic fluid.

18. A fluid delivery system for fire-fighting vehicles comprising:
a hydraulic system including a hydraulic pump coupled to a hydraulic manifold block, a characteristic of hydraulic fluid in the hydraulic system changing in response to engagement of the hydraulic pump;
a water pump in communication with the hydraulic pump whereby the hydraulic pump is automatically engaged upon engagement of the water pump;
a compressed air injection system coupled to the hydraulic system;
means for detecting a change in the characteristic of the hydraulic fluid; and
means for automatically engaging the compressed air injection system upon detection of the change in the characteristic of the hydraulic fluid.

19. A fluid delivery system as in claim 18, further comprising:
an additive injection system.
